(19) United States
(12) Patent Application Publication
(10) Pub. No.: US 2003/0215019 A1
(43) Pub. Date: Nov. 20, 2003

(54) Audio/video separator including a user data start address register

(75) Inventor: Chiho Iganami, Tokyo (JP)

Correspondence Address: FOLEY AND LARDNER, SUITE 500, 3000 K STREET NW, WASHINGTON, DC, 20007, US

(73) Assignee: NEC Corporation

(21) Appl. No.: 10/463,694

(22) Filed: Jun. 18, 2003

Related U.S. Application Data
(63) Continuation of application No. 09/189,147, filed on Nov. 10, 1998, now Pat. No. 6,625,218.

(30) Foreign Application Priority Data
Nov. 20, 1997 (JP) 9-307283

(51) Int. Cl. H04N 7/12

(52) U.S. Cl. 375/240.25; 375/240.16

(57) ABSTRACT

The present invention provides an MPEG decoder which prevents user data, which is in video code data of MPEG-compressed code data, from being overwritten by the next code data before a CPU reads the user data. The MPEG decoder has an audio/video separator 3 and a memory. The audio/video separator 3 has a start code detector 11 which, in turn, has a start code start address register 12 and a start code register 13. When the MPEG decoder receives compressed code data, the start the code detector 11 searches the compressed code data for a start code specified by the start code register 13 and stores the start address of the start code into the start code start address register 12.

### CROSS-REFERENCE TO RELATED PATENT APPLICATIONS

This application is a continuation of application Ser. No. 09/189,147, filed Nov. 10, 1998, now pending, and based on Japanese Patent Application No. 9-307283, filed November 20, 1997, by Chiho IGANAMI. This application claims only subject matter disclosed in the parent application and therefore presents no new matter.

### BACKGROUND OF THE INVENTION

1. Field of the Invention

The present invention relates to a decoder which decodes code data produced by compressing audio/video signals (A/V signals). In particular, the present invention relates to an MPEG decoder which detects and extracts MPEG-coded user data included in video code data.

2. Description of the Related Art

MPEG-compressed video data is processed during decoding in six hierarchical layers: sequence layer, GOP (Group Of Picture) layer, picture layer, slice layer, macro block layer, and block layer. User data, composed of a sequence header, one or more GOPs, and a sequence end code, is added to video data; it is added to video data as necessary in the sequence layer, GOP layer, and picture layer. User data may be used to add superimposed dialogs or scene-searching information to the video code. During decoding, the CPU reads user data to display superimposed dialogs or to search for a scene. In each layer, video data and user data begin with 4-byte code areas each containing a unique start code. During decoding, this start code is used to identify a data hierarchy and a user data area.

FIG. 9 is a block diagram showing a conventional MPEG decoder. As shown in the figure, an MPEG decoder 1 comprises a stream interface 2, an audio/video separator (hereafter called an A/V separator 3), a memory interface 4, an audio decoder 5, and a video decoder 6. The video decoder 6 has a start code detector 15 which, in turn, has a user data start address register 16.

The stream interface 2 receives code data (DATA), and outputs data signals (DATA′) to the A/V separator 3. The A/V separator 3 outputs two types of data signals, A_DATA and V_DATA, to the memory interface 4. The memory interface 4 outputs a data signal A_DATA′ to the audio decoder 5, and a data signal V_DATA′ to the video decoder 6. The audio decoder 5 outputs a data request signal A_REQ to the memory interface. The video decoder 6 outputs a data request signal V_REQ to the memory interface. The start code detector 15 outputs a user data detection signal SCD_DET to a CPU 9. The CPU 9 outputs an address signal REG_ADD and a read request signal REG_READ to the MPEG decoder 1, and the MPEG decoder 1 outputs a data signal OUT_DATA to the CPU 9. The following describes the operation.

Code data (DATA) that is input to the MPEG decoder 1 conforms to the MPEG standard. This data is composed of two types of data: compressed audio code data and compressed video code data. These two types of data, each with an appropriate length, are switched as necessary. Upon receiving this code data (DATA), the stream interface 2 synchronizes it with the internal clock signal and sends the data signal (DATA′) to the A/V separator 3. The A/V separator 3 separates the data signal DATA′ into two types of code data—audio code data and video code data—and outputs them to the memory interface 4 as two separate data signals, one as A_DATA and the other as V_DATA. The memory interface 4 stores in memory the audio code data (A_DATA) and the video code data (V_DATA). When decoding, the audio decoder 5 sets the data request signals A_REQ high, and the video decoder 6 sets V_REQ high, as necessary (When these decoders do not request data, A_REQ and V_REQ remain low.) When A_REQ goes high, the memory interface 4 outputs the audio code data to the audio decoder 5 via the data signal line A_DATA′; when V_REQ goes high, the memory interface 4 outputs the video code data to the video decoder 6 via the data signal line V_DATA′.

The video decoder 6 causes the start code detector 15 to detect a start code contained in the video code data received via the data signal line V_DATA′. When the start code detector 15 detects the start code of data of a layer, the video decoder 6 performs decoding processing corresponding to that layer. When the video decoder 6 detects the start code of user data, the video decoder 6 stores the start byte address of the user data into the user data start address register 16 and sets the user data detection signal SCD_DET high (SCD_DET remains low when user data is not detected).

The CPU 9 reads data stored in the memory interface 4 via a register whose address is different from that of the user data start address register 16. When the CPU 9 reads data from the MPEG decoder 1, it sets the read request signal REG_READ low and specifies an address via the address signal REG_ADD. This allows data stored in each register to be read via the data signal line OUT_DATA (When the CPU 9 does not read data, REG_READ remains high.) When the user data detection flag SCD_DET is high, the CPU 9 reads the address from the user data start address register 16 and extracts user data, beginning with the address in the memory interface specified by the user data start address register 16, until the next start code is detected.

One of the problems with the conventional method is that the next code data is input into the memory interface 4 before the CPU 9 completes the extraction of user data from the MPEG decoder 1. This prevents the CPU 9 from extracting the user data correctly.

Code data is input to the MPEG decoder 1 independently of the memory data read operation executed by the CPU 9. That is, code data is written into memory interface 4 whenever there is a free memory area. When the video decoder 6 decodes code data, the decode operation executed by the video decoder 6 involves a decoding delay. Therefore, while the code data is decoded, the address used by the A/V separator 3 to write data into the memory interface 4 via V_DATA is also used, in most cases, by the video decoder 6 to read data from the memory interface 4. However, when the video decoder 6 decodes user data, no decoding delay is generated because the video decoder 6 does not decode the user data but skips it and keeps on reading code data from the memory interface 4 until the start code of the next video data to be decoded is detected. This generates a free area in the memory into which the next data is read before the CPU 9 reads the user data, sometimes preventing the CPU 9 from reading the user data correctly. That is, the above problem depends, to some extent, on the data read speed of the CPU 9; the problem is generated when the speed at which data is read by the CPU 9 via the data signal OUT_DATA is slower than the speed at which data (DATA) is input to the stream interface 2.

To avoid the above problem, the CPU must read user data more quickly. For the CPU to read data more quickly, it is necessary to reduce the cycle time between the time the MPEG decoder 1 detects that the CPU 9 sets the read request signal REG_READ low and the time data is output from memory to the data signal line OUT_DATA. This requires that the MPEG decoder 1 output data to CPU 9 more quickly or that the MPEG decoder 1 be re-designed to suit the data read speed of the CPU 9.

However, an increase in the speed at which data is output from the MPEG decoder 1 to the CPU 9 results in an increase in the LSI size, increasing the production cost. On the other hand, the need to prepare the MPEG decoder 1 specifically designed for the data read speed of the CPU 9 requires many types of MPEG decoders, increasing the development cost.

### SUMMARY OF THE INVENTION

It is an object of the present invention to provide a decoding method and a decoder which allow the CPU to extract user data from the decoder at any data read speed of the CPU.

To achieve the above object, A decoding method of the present invention for decoding audio/video compressed code data, said video code data containing a first code indicating a type of data, said decoding method comprising the steps of: (a) receiving the code data; (b) separating the code data into the audio code data and the video code data; (c) checking if the code data is the video code data; (d) executing processing according to said first code contained in the video code data; and (e) decoding the code data and outputting the decoded code data.

MPEG decoding method according to the present invention is a decoding method for decoding MPEG-compressed code data, the code data composed of audio code data and video code data, the video code composed of hierarchical data and user data each preceded by a first start code, wherein a user data start address register is provided to store the start address of the user data, the decoding method comprising the steps of: (a) receiving the code data; (b) separating the code data into the audio code data and the video code data; (c) checking if the code data is the video code data; (d) if the code data is the video code data, if the code data is the video data, and if the user data is detected in the video data, storing an address of the start byte of the user data into the user data start address register and storing the address of a start byte of the user data into the user data start address register; and turning a signal on, the signal indicating that the user data was detected; and (e) decoding the code data and outputting the decoded code data.

According to the present invention, the CPU receives, before code data entered into the decoder is decoded, a user data detection signal indicating that the code data contains user data. Upon receiving this signal, the CPU turns on the read request signal, with the address of the user data start address register specified, to read the address from that register. The CPU then reads data, beginning at the address specified by the user data start address register, until the next start code is detected. In this way, the CPU extracts the user data.

The MPEG decoder according to the present invention allows the CPU to read user data from the MPEG decoder regardless of the speed at which the CPU reads data.

An A/V separator, included in the MPEG decoder according to the present invention, has a user data detector which, upon detection of user data in entered code data, immediately outputs the user data detection signal to the CPU, with no decoding delay introduced by a video decoder, so that the CPU can start extracting the user data immediately. Therefore, even when the CPU is slower than the speed at which code data is stored into the memory, the CPU can extract user data before the memory containing the user data is updated by the next code data. This means that the CPU can extract user data regardless of the speed at which the CPU reads the user data.

Thus, the present invention eliminates the need to consider the speed at which the CPU reads user data from the MPEG decoder and therefore eliminates the need to increase the speed at which data is output from the MPEG decoder to the CPU. This results in a smaller LSI or eliminates the need for the MPEG decoder to be specifically designed for the speed of the CPU, thus lowering the development cost.

### BRIEF DESCRIPTION OF THE DRAWINGS

FIG. 1 is a block diagram showing the configuration of the first embodiment of the MPEG decoder of the present invention;

FIG. 2 is a flowchart showing the first embodiment of the MPEG decoder according to the present invention.

FIG. 3 is a block diagram showing the configuration of the second embodiment of the MPEG decoder of the present invention;

FIG. 4 is a flowchart showing the second embodiment of the MPEG decoder according to the present invention.

FIG. 5 is a block diagram showing the configuration of the third embodiment of the MPEG decoder of the present invention;

FIG. 6 is a flowchart showing the third embodiment of the MPEG decoder according to the present invention.

FIG. 7 is a block diagram showing the configuration of the fourth embodiment of the MPEG decoder of the present invention;

FIG. 8 is a flowchart showing the fourth embodiment of the MPEG decoder according to the present invention.

FIG. 9 is a block diagram of an example of a conventional MPEG decoder.

### DETAILED DESCRIPTION OF THE PREFERRED EMBODIMENTS

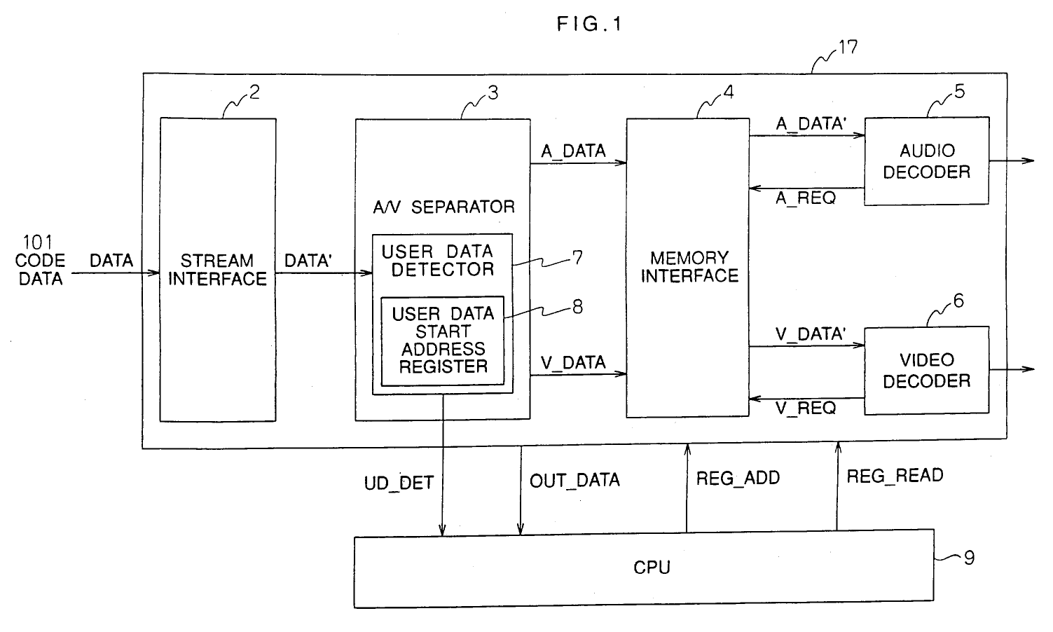

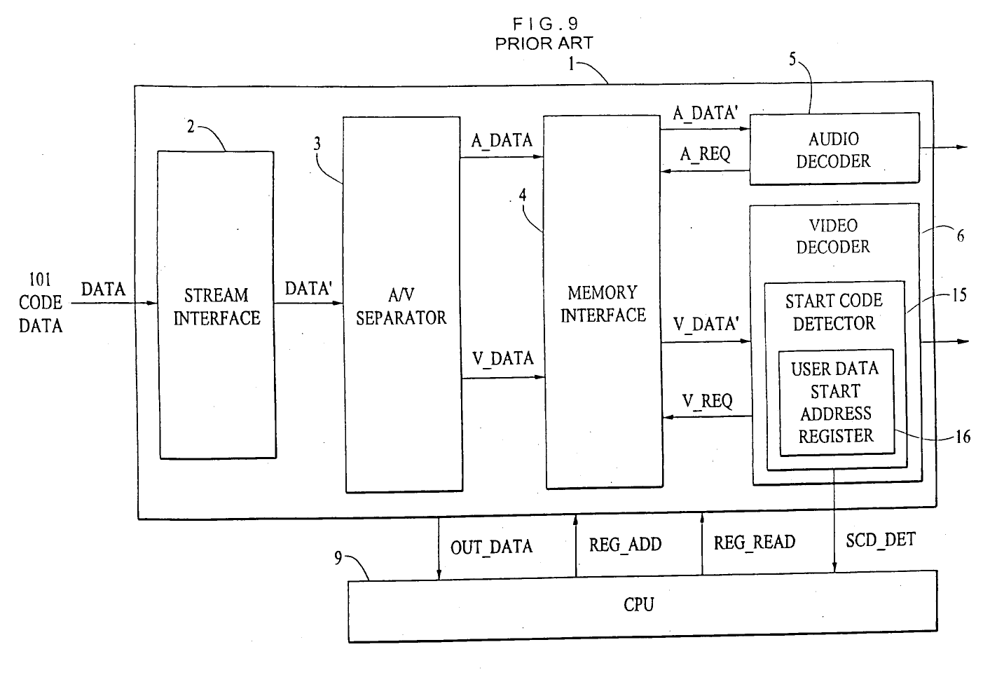

The first embodiment of the present invention will be described with reference to FIG. 1. The numbers of components in FIG. 1 corresponding to those in FIG. 9 are the same. In the figure, an MPEG decoder 17 has a stream interface 2, an A/V separator 3, a memory interface 4, an audio decoder 5, and a video decoder 6. The A/V separator 3 has a user data detector 7 which contains a user data start address register 8.

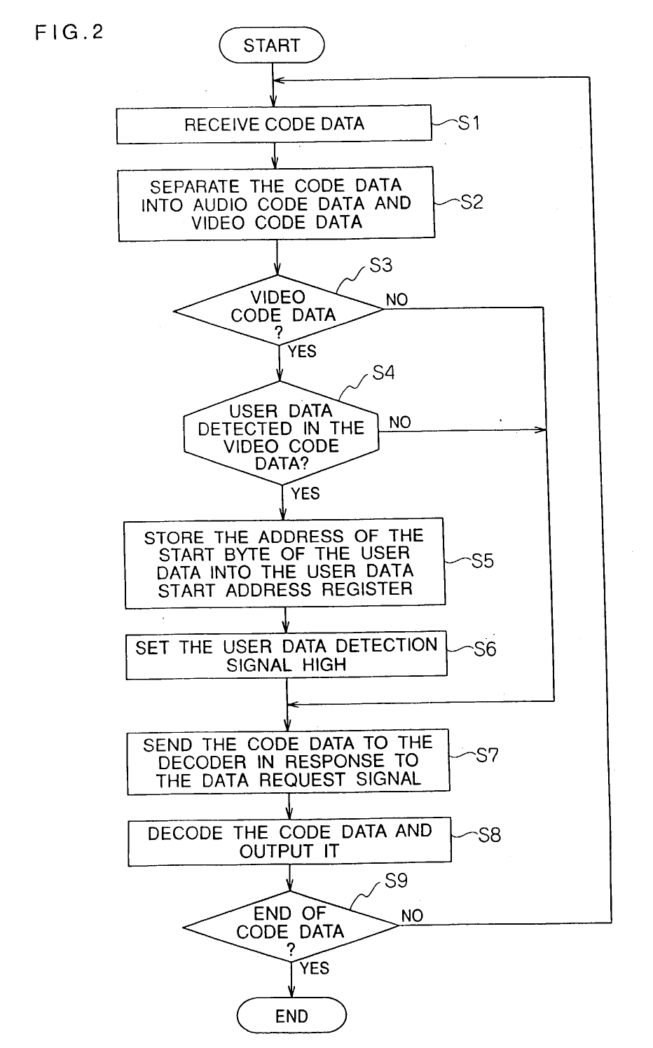

The stream interface 2 receives code data (DATA) and outputs data signals (DATA′) to the A/V separator 3. The A/V separator 3 outputs two types of data signals, A_DATA and V_DATA, to the memory interface 4. The memory interface 4 outputs a data signal A_DATA′ to the audio decoder 5, and a data signal V_DATA′ to the video decoder 6. The audio decoder 5 outputs a data request signal A_REQ to the memory interface 4. The video decoder 6 outputs a data request signal V_REQ to the memory interface 4. The user data detector 7 outputs a user data detection signal UD_DET to the CPU 9. The CPU 9 outputs an address signal REG_ADD and a read request signal REG_READ to the MPEG decoder 17, and the MPEG decoder 17 outputs a data signal OUT_DATA to the CPU 9. The following describes the operation with reference to FIG. 2.

Code data (DATA) that is input to the MPEG decoder 17 conforms to the MPEG standard. This data is composed of two types of data: compressed audio code data and compressed video code data. These two types of data, each with an appropriate length, are switched as necessary. Upon receiving code data (DATA), the stream interface 2 synchronizes it with the internal clock signal and sends the data signal (DATA′) to the A/V separator 3. The A/V separator 3 separates the data signal DATA′ into two types of code data—audio code data and video code data—and outputs them to the memory interface 4 as two data signals, one as A_DATA and the other as V_DATA. The memory interface 4 stores in memory the audio code data (A_DATA) and the video code data (V_DATA). The audio decoder 5 sets the data request signals A_REQ high, and the video decoder 6 sets the data signal V_REQ high, as necessary (When these decoders do not request data, A_REQ and V_REQ remain low). When A_REQ goes high, the memory interface 4 outputs the audio code data to the audio decoder 5 via the data signal line A_DATA′; when V_REQ goes high, the memory interface 4 outputs the video code data to the video decoder 6 via the data signal line V_DATA′.

When the user data detector 7 detects user data in the data signal V_DATA′ that is output from the A/V separator 3 to the video decoder 6, it stores the user data start byte address into the user data start address register 8 and sets the user data detection signal UD_DET high (When the user data is not detected, UD_DET remains low.)

The CPU 9 reads data stored in the memory interface 4 via a register whose address is different from that of the user data start address register 8. When the CPU 9 reads data from the MPEG decoder 1, it sets the read request signal REG_READ low and specifies an address via the address signal REG_ADD. This allows data stored in each register to be read via the data signal line OUT_DATA (When the CPU 9 does not read data, REG_READ remains high.) When the user data detection flag UD_DET is high, the CPU 9 reads the address from the user data start address register 8 and extracts user data, beginning with the memory address specified by the user data start address register 8, until the next start code is detected.

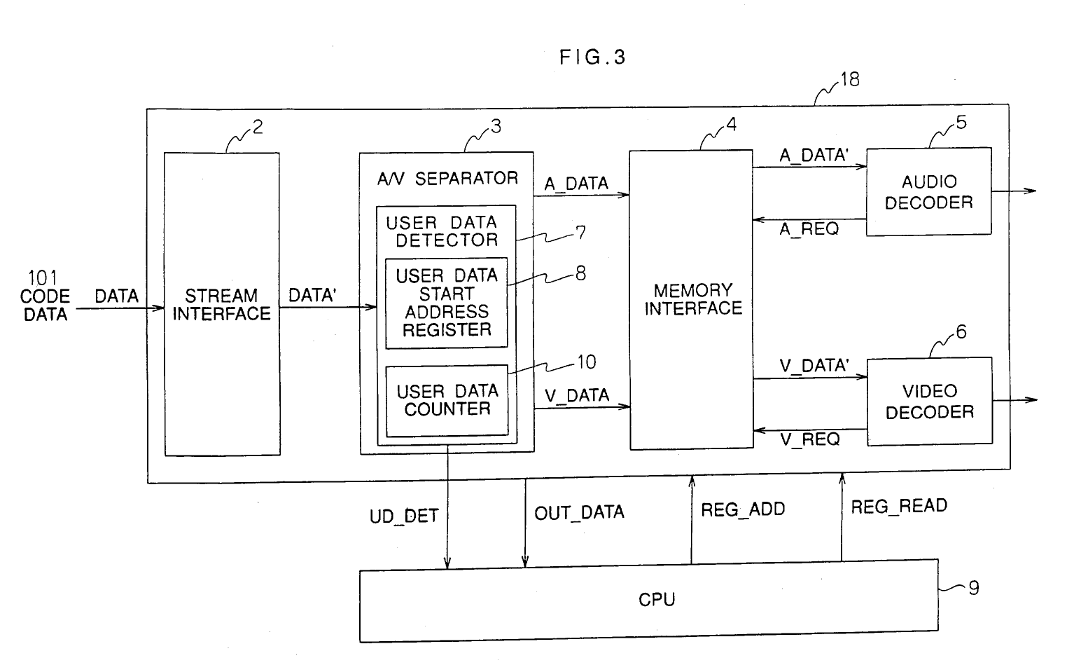

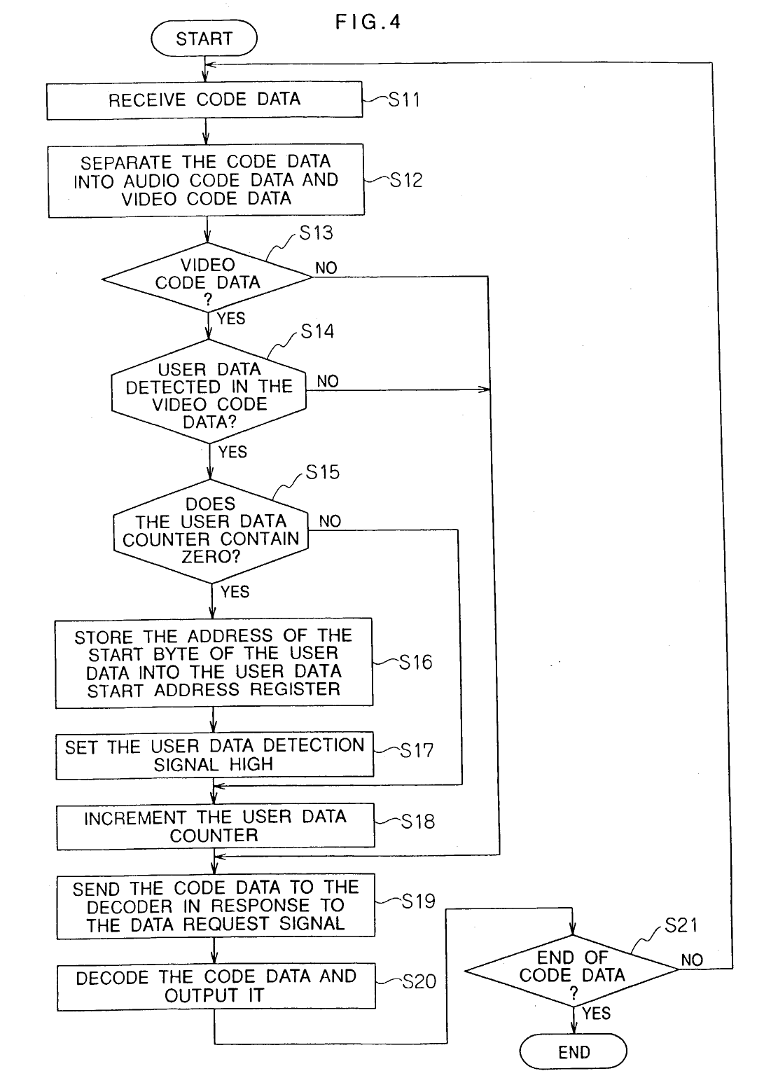

Next, the second embodiment of the present invention will be described with reference to FIGS. 3 and 4. An MPEG decoder 18 of the second embodiment differs from that of the first embodiment in that the user data detector 7 has a user data counter 10. The following describes how the MPEG decoder 18 differs in operation from that of the first embodiment.

The A/V separator 3 causes the user data detector 7 to detect user data included in the data signal V_DATA′ that is output to the video decoder 6. Upon detecting user data, the user data detector 7 stores into the user data start address register 8 the address of the start byte of the user data in memory only when the user data counter 10 is 0 and sets the user data detection signal UD_DET high (When user data is not detected, UD_DET remains low). Then, the user data detector 7 increments the user data counter 10. The user data counter 10, a register read by the CPU 9, has an address different from that of the register containing user data in the memory interface 4 or from that of the user data start address register 8. When the user data detection flag UD_DET is high, the CPU 9 reads the user data start address register 8 and the user data counter 10. When read by the CPU 9, the user data counter 10 is cleared to 0. The CPU 9 searches the memory interface 4 for user data and extracts it for the number of times specified by the user data counter 10, beginning at the memory address specified by the user data start address register 8.

In the second embodiment, the CPU 9 is able to extract all user data even when a plurality of user data pieces are detected before the CPU 9 starts reading user data.

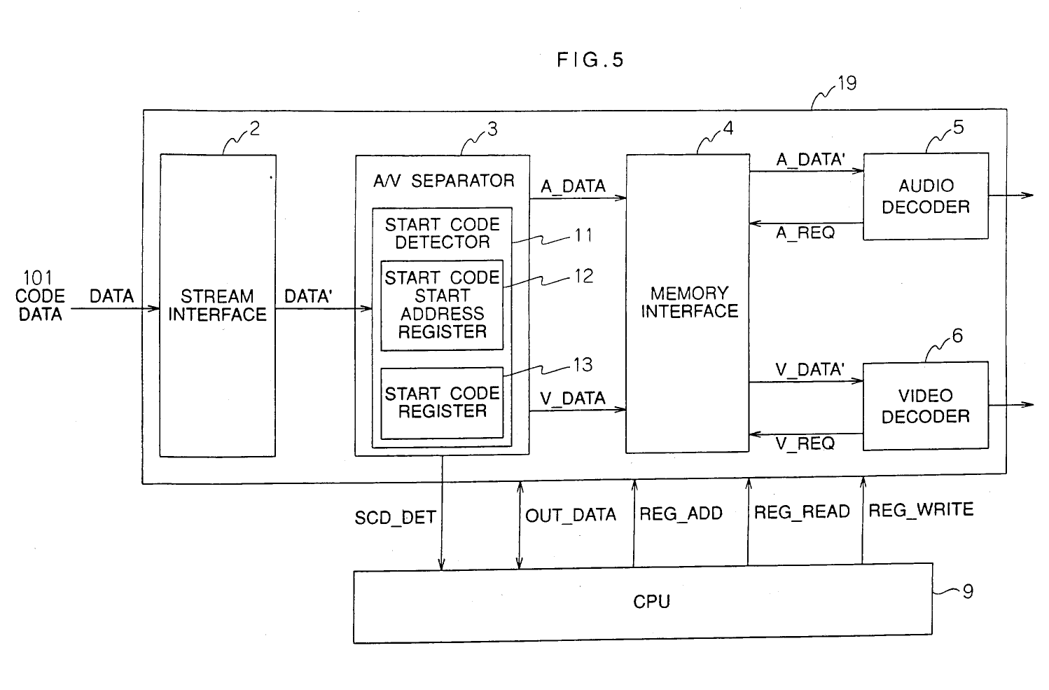

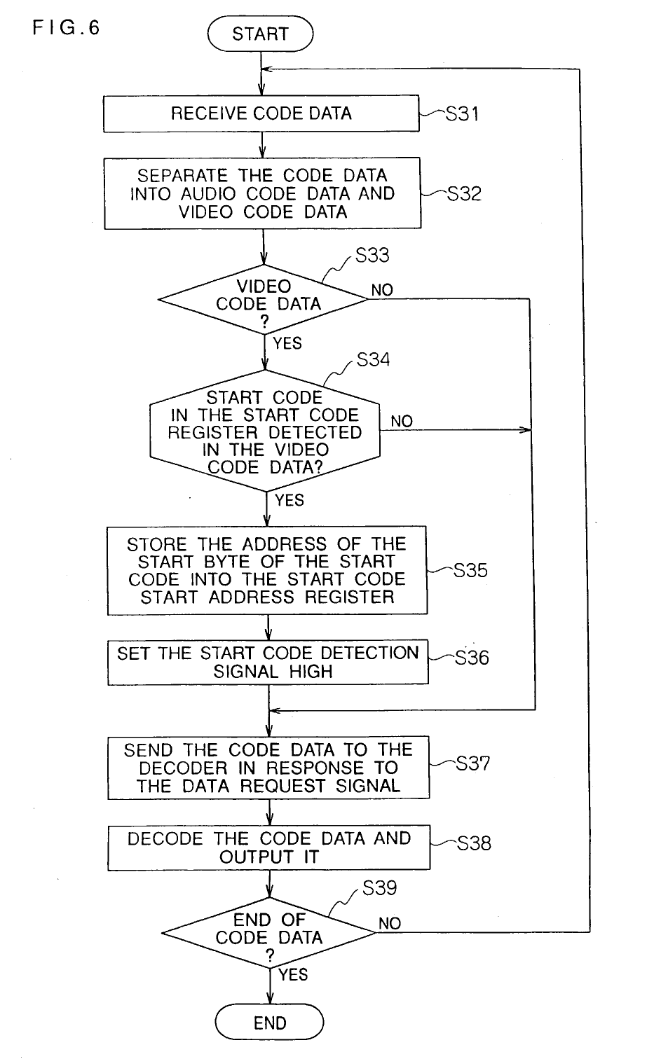

Next, the third embodiment of the present invention will be described with reference to FIGS. 5 and 6. An MPEG decoder 19 differs from the MPEG decoder 17 of the first embodiment in the following points. That is, the A/V separator 3 has a start code detector 11 which, in turn, has a start code start address register 12 and a start code register 13. The start code detector 11 outputs the start code detection signal SCD_DET to the CPU 9, the CPU 9 outputs the write request signal REG_WRITE to the MPEG decoder 19, and the OUT_DATA signal is used as the input/output signal. The following describes how the MPEG decoder 19 differs in operation from the MPEG decoder 17 of the first embodiment.

As described below, the CPU 9 reads an address from the start code start address register 12, while the CPU 9 writes a start code into the start code register 13. The register in the memory interface 4, the user data start address register 12, and the start code register 13 each have unique register addresses. The CPU 9 specifies the address of the start code register 13 via the address signal REG_ADD, outputs a user data start code via the data signal OUT_DATA to write it into the start code register 13, and then sets the write request signal REG_WRITE low. The A/V separator 3 uses the start code detector 11 to search the data signal V_DATA′, which is sent to the video decoder 6, for the start code stored in the start code register 13. Upon detecting the start code, the start code detector 11 stores the address of the start byte of the start code into the start code start address register 12 and sets the start code detection signal SCD_DET high (When the start code is not detected, the SCD_DET remains low.) When the start code detection flag SCD_DET is high, the CPU 9 reads the start code start address register 12 and reads and extracts user data from the address specified by the start code start address register 12 to the address at which the next start code is detected.

In the third embodiment, the start code of non-user data may be specified in the start code register 13. Then, code data having the specified start code may also be extracted.

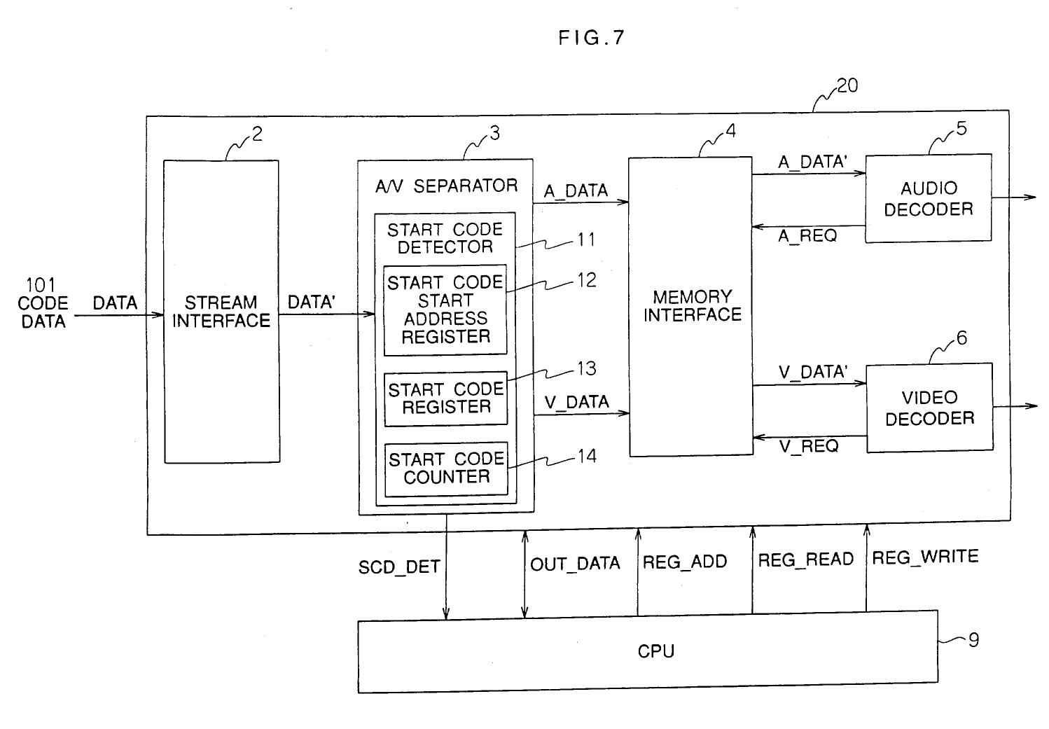

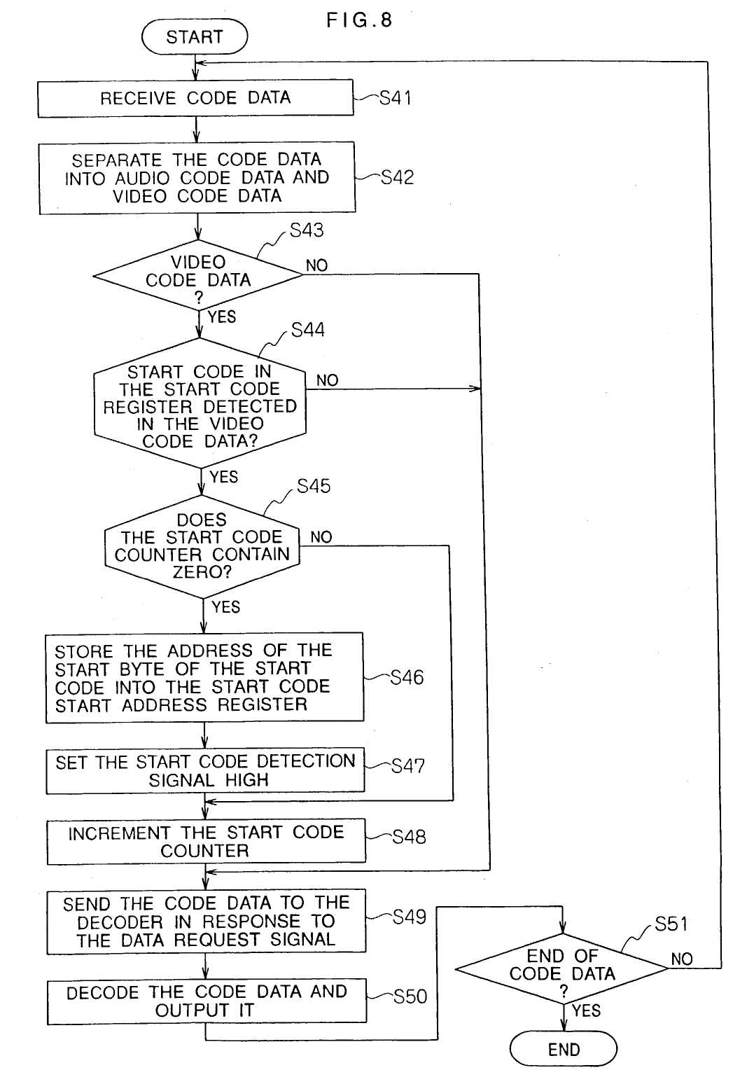

Next, the fourth embodiment of the present invention will be described with reference to FIGS. 7 and 8. An MPEG decoder 20 differs from the MPEG decoder 19 of the third embodiment in that the start code detector 11 has a start code counter 14. The following describes how the MPEG decoder 20 differs in operation from the MPEG decoder 19 of the third embodiment.

The start code detector 11 searches the data code signal V_DATA′, sent from the A/V separator 3 to the video decoder 6, for the start code stored in the start code register 13. Upon detecting the start code, the start code detector 11 stores the address of the start byte of the start code into the start code start address register 12 and sets the start code detection signal SCD_DET high only when the start code counter 14 is 0 (When the start code is not yet detected, SCD_DET remains low.) Then, the start code detector 11 increments the start code counter 14. The start code counter 14, which is a register read by the CPU 9, has an address different from that of the register in the memory interface 4 and from that of the start code start address register 12. When the start code detection flag SCD_DET is high, the CPU 9 reads the address from the start code start address register 12 and the count from the start code counter 14. When read by the CPU 9, the start code counter 14 is cleared to 0. The CPU 9 searches the memory interface 4 for the start code specified by the start code counter 14 and extracts user data, beginning at the memory address specified by the start code start address register 12 for the number of times specified by the start code counter 14.

In the fourth embodiment, even when a plurality of start codes are found before the CPU 9 starts reading the start code, all the start codes may be extracted. It is also possible to specify a non-user data start code in the start code register 13 to extract other start codes from video code.

The invention may be embodied in other specific forms without departing from the spirit or essential characteristic thereof. The present embodiments is therefore to be considered in all respects as illustrative and not restrictive, the scope of the invention being indicated by the appended claims rather than by the foregoing description and all changes which come within the meaning and range of equivalency of the claims and therefore intended to be embraced therein.

The entire disclosure of Japanese Patent Application No. 9-307289 (Filed on Nov. 11, 1997) including specification, claims, and summary are incorporated herein by reference in its

What is claimed is:

1. An MPEG decoder comprising:
an audio/video separator; and
a memory interface;
wherein the MPEG decoder is connected to a CPU which processes a user data, and
wherein the audio/video separator comprises:
a detecting means, which conforms to an MPEG standard, for inputting a compressed code data, extracting an audio code data and a video code data from the code data, detecting a start code of the user data from the code data, and outputting a user data detection signal to the CPU; and
a register means for storing an address information necessary for the CPU to obtain the user data written in a memory.

2. The MPEG decoder as claimed in claim 1, wherein the detecting means detects, from the code data, the start code of the user data that must be output by the audio/video separator and stores into the register means a start byte address of the user data stored in the memory, and contents of the register means are able to be read by the CPU.

3. The MPEG decoder as claimed in claim 2, wherein the audio/video separator further comprises a counting means for counting a number of the user data in the code data detected in the detecting means, and the detecting means stores into the register means the start byte address of the start code of the user data which is detected first among the user data stored in the memory.

4. The MPEG decoder as claimed in claim 1, wherein the audio/video separator, which conforms to the MPEG standard and inputs the compressed code data, comprises the detecting means ad the register means, wherein
the detecting means detects the start code, which is designated in the register means, of the user data from the cede data, outputs the start code detection signal to the CPU, and stores into the register means a start byte address of the start code which must be written in the memory.

5. The MPEG decoder as claimed in claim 4, wherein the register means comprises:
a start code start address register which contains the start byte address of the start code stored in the memory and from which the CPU is able to read; and
a start code register which contains the start code and in which the CPU is able to write.

6. The MPEG decoder as claimed in claim 4, wherein the audio/video separator further comprises a counting means for counting the start code through detecting, from the code data, the start code designated in the register means among the code data detected in the detecting means, and the detecting means stores into the register means the start byte address, written in the memory, of the start code which is detected first.
